(19) United States
(12) Patent Application Publication
(10) Pub. No.: US 2024/0332484 A1
(43) Pub. Date: Oct. 3, 2024

(54) METHOD FOR MANUFACTURING NON-AQUEOUS SECONDARY BATTERY ELECTRODE

(71) Applicant: HONDA MOTOR CO., LTD., Tokyo (JP)

(72) Inventors: Masanari HIGUCHI, Saitama (JP); Masahiro OHTA, Saitama (JP)

(21) Appl. No.: 18/583,880

(22) Filed: Feb. 22, 2024

(30) Foreign Application Priority Data
Mar. 28, 2023 (JP) 2023-051118

(51) Int. Cl. H01M 4/04; H01M 4/62; H01M 4/66; H01M 10/0525

(52) U.S. Cl. CPC H01M 4/0409; H01M 4/0435; H01M 4/622; H01M 4/661; H01M 10/0525

(57) ABSTRACT

An object is to provide a method for manufacturing a non-aqueous secondary battery electrode in which a bonding between the positive electrode layer and a solid electrolyte layer can be made more continuous or stronger. A method for manufacturing a non-aqueous secondary battery electrode includes: preparing a positive electrode layer solution that includes a positive electrode active material, a binder and a first solvent; forming a positive electrode layer using the positive electrode layer solution; forming an electrolyte layer that includes a solid electrolyte; preparing an adhesive layer solution that includes a solid electrolyte and a second solvent; forming an adhesive layer using the adhesive layer solution; and stacking the positive electrode layer, the adhesive layer and the electrolyte layer in this order, and the second solvent has a higher solubility for the binder than the first solvent.

This application is based on and claims the benefit of priority from Japanese Patent Application No. 2023-051118, filed on 28 Mar. 2023, the content of which is incorporated herein by reference.

### BACKGROUND OF THE INVENTION

### Field of the Invention

The present invention relates to a method for manufacturing a non-aqueous secondary battery electrode.

### Related Art

In recent years, research and development has been conducted on secondary batteries which contribute to energy efficiency in order to ensure that more people have access to affordable, reliable, sustainable and advanced energy.

As the secondary battery described above, a non-aqueous secondary battery such as a lithium-ion secondary battery is known in which an electrolyte layer is arranged between a positive electrode layer and a negative electrode layer. In the non-aqueous secondary battery, an interface between an electrode layer and the electrolyte layer is a solid contact, and ion path formation is an important issue. However, the mechanical bonding strength of the interface is low, and the bonding is a dissimilar material bonding, with the result that it is necessary to improve the strength against an interfacial strain which potentially occurs. As a technique for maintaining the stability of the interface between the electrode layer and the electrolyte layer, a technique is known in which the binding agent of the electrode layer is crosslinked using a crosslinking agent (for example, see Patent Document 1).

In addition, as a technique which can form a satisfactory interface between solid particles, there is a known technique related to an all-solid secondary battery which has an intermediate layer including a compound such as Li₂Ti₂O₅ between a solid electrolyte layer and a negative electrode active material layer (for example, see Patent Document 2).
Patent Document 1: Japanese Unexamined Patent Application, Publication No. 2014-116164
Patent Document 2: Japanese Unexamined Patent Application, Publication No. 2016-212991

### SUMMARY OF THE INVENTION

In the technique disclosed in Patent Document 1, a positive electrode and a negative electrode include a non-polar binding agent, and the binding agent is crosslinked using a crosslinking agent. Then, the positive electrode and the negative electrode, and the electrolyte layer are bound by the non-polar binding agent. In the technique disclosed in Patent Document 2, the intermediate layer is arranged between the solid electrolyte layer and the negative electrode active material layer, and thus a satisfactory interface is formed between the negative electrode active material layer and the solid electrolyte layer. On the other hand, the bonding of a positive electrode layer and the solid electrolyte layer is preferably made more continuous or stronger.

The present invention is made in view of the foregoing, and an object of the present invention is to provide a method for manufacturing a non-aqueous secondary battery electrode in which a bonding between a positive electrode layer and a solid electrolyte layer can be made more continuous or stronger.

(1) A first aspect relates to a method for manufacturing a non-aqueous secondary battery electrode, including: preparing a positive electrode layer solution that includes a positive electrode active material, a binder and a first solvent; forming a positive electrode layer using the positive electrode layer solution; forming an electrolyte layer that includes a solid electrolyte; preparing an adhesive layer solution that includes a solid electrolyte and a second solvent; forming an adhesive layer using the adhesive layer solution; and stacking the positive electrode layer, the adhesive layer and the electrolyte layer in this order. The binder has a larger solubility in the second solvent than in the first solvent.

According to the invention of (1), the amount of binder eluted in an interface between the positive electrode layer and the adhesive layer can be increased. In this way, it is possible to provide the method for manufacturing a non-aqueous secondary battery electrode in which a bonding between the positive electrode layer and the solid electrolyte layer can be made more continuous or stronger.

(2) A second aspect relates to the method for manufacturing a non-aqueous secondary battery electrode as described in (1), in which the second solvent has a lower boiling point than the first solvent.

According to the invention of (2), since the second solvent volatilizes smoothly after the binder fills voids at the interface between the positive electrode layer and the adhesive layer, the interface is easily filled with the binder, with the result that voids are unlikely to be generated at the interface. Hence, bondability between the positive electrode layer and the adhesive layer can be further enhanced.

(3) A third aspect relates to the method for manufacturing a non-aqueous secondary battery electrode described in (1) or (2), in which in the stacking, when the positive electrode layer and the adhesive layer are stacked, the second solvent is present at least in the adhesive layer.

According to the invention of (3), the anchoring effect of the binder included in the positive electrode layer is exerted, and thus bondability between the positive electrode layer and the adhesive layer can be further enhanced.

(4) A fourth aspect relates to the method for manufacturing a non-aqueous secondary battery electrode described in any one of (1) to (3), in which the adhesive layer solution does not include a binder.

According to the invention of (4), the elution of the binder included in the positive electrode layer caused by the second solvent and the penetration of the binder into the adhesive layer are further facilitated, and thus bondability between the positive electrode layer and the adhesive layer can be further enhanced.

(5) A fifth aspect relates to the method for manufacturing a non-aqueous secondary battery electrode described in any one of (1) to (3), in which the adhesive layer solution includes the same type of binder as the binder included in the positive electrode layer solution.

According to the invention of (5), the compatibility between the binder included in the positive electrode layer and the binder included in the adhesive layer is enhanced, and thus the positive electrode layer and the adhesive layer can be made more continuous or stronger.

### BRIEF DESCRIPTION OF THE DRAWINGS

FIG. 1 is a diagram showing a state where a positive electrode layer and an adhesive layer in the present embodiment are stacked; and

FIG. 2 is a diagram showing a bonding state of the positive electrode layer and the adhesive layer in the present embodiment.

### DETAILED DESCRIPTION OF THE INVENTION

The method for manufacturing a non-aqueous secondary battery electrode according to the present embodiment is a method for manufacturing a non-aqueous secondary battery electrode which includes at least a positive electrode layer, an electrolyte layer and an adhesive layer stacked between these layers in a non-aqueous secondary battery. The non-aqueous secondary battery includes at least a negative electrode layer in addition to the layers described above. The negative electrode layer is stacked in contact with the electrolyte layer.

### [Non-Aqueous Secondary Battery]

Examples of the non-aqueous secondary battery in the present embodiment include a semi-solid lithium ion battery which includes a gel electrolyte, an all-solid lithium ion battery which includes a solid electrolyte and the like. As the non-aqueous secondary battery, in particular, a semi-solid lithium ion metal battery or an all-solid lithium ion metal battery in which lithium metal is used as a negative electrode is preferable. Since these solid-state batteries have relatively large expansion and contraction caused by charging and discharging, and thus it is desired to have stronger bonding strength of a positive electrode layer and a solid electrolyte layer, these solid-state batteries are preferable because in the method for manufacturing a non-aqueous secondary battery electrode according to the present embodiment, the bonding between the positive electrode layer and the solid electrolyte layer can be made more continuous or stronger.

### (Positive Electrode Layer)

The positive electrode layer includes a positive electrode active material layer and a positive electrode current collector. In the present embodiment, the positive electrode active material layer is stacked on each of both surfaces of the positive electrode current collector, and furthermore, the adhesive layer is stacked on the outer surface of each of the positive electrode active material layers.

The positive electrode active material layer includes a positive electrode active material as an essential material. The positive electrode active material is not particularly limited, and a known material which serves as a positive electrode active material for a non-aqueous secondary battery can be used. As the positive electrode active material, for example, ternary positive electrode materials such as LiCoO₂, LiNiO₂ and NCM (Li(NixCoyMnz)O₂ (0<x<1, 0<y<1, 0<z<1, x+y+z=1)), layered positive electrode active material particles such as LiVO₂ and LiCrO₂, spinel type positive electrode active materials such as LiMn₂O₄, Li(Ni_{0.25}Mn_{0.75})₂O₄, LiCoMnO₄ and Li₂NiMn₃O₈ and olivine-type positive electrode active materials such as LiCoPO₄, LiMnPO₄ and LifePO₄ can be used.

The positive electrode active material layer includes a binder in addition to the positive electrode active material. The positive electrode active material layer may further include a solid electrolyte, a conductive aid and the like. The solid electrolyte, the conductive aid, the binder and the like are not particularly limited, and known materials which serve as electrode materials for a non-aqueous secondary battery can be applied.

Although the binder is not particularly limited, it is preferable to use a particulate or fibrous binder which does not interfere with bulk contact between particles. Examples of the type of binder include polyvinylidene fluoride (PVdF), polymethyl methacrylate (PMMA), polyisobutene (PIB), styrene butadiene rubber (SBR), polyethylene-vinyl acetate copolymer (PEVA), nitrile rubber (NBR), hydrogenated nitrile rubber (HNBR) and the like. One of these types may be used singly or two or more types may be used together.

The positive electrode current collector is not particularly limited, and a known material which serves as a positive electrode current collector for a non-aqueous secondary battery can be used. Examples of the positive electrode current collector include metal foils such as a stainless steel (SUS) foil and an aluminum (Al) foil.

### (Adhesive Layer)

The adhesive layer is a layer which is stacked between the positive electrode layer and the electrolyte layer. The bonding between the positive electrode layer and the electrolyte layer can be made more continuous or stronger by the adhesive layer. The adhesive layer includes a solid electrolyte as an essential material. The adhesive layer includes the solid electrolyte, and thus ion conductivity between the positive electrode layer and the electrolyte layer can be enhanced. The solid electrolyte included in the adhesive layer is not particularly limited, and a known material which serves as an electrode material for a non-aqueous secondary battery can be applied.

The adhesive layer may include a binder. When a binder is included in the adhesive layer, the type of binder is preferably the same type as the binder included in the positive electrode layer. As the origin of the binder included in the adhesive layer, there are a case where a binder included in an adhesive layer solution described later is included in the adhesive layer and a case where the binder included in the positive electrode layer is moved to be included in the adhesive layer.

### (Negative Electrode Layer)

The negative electrode layer includes a negative electrode active material layer and a negative electrode current collector. In the present embodiment, the negative electrode active material layer is stacked in contact with the electrolyte layer, and the negative electrode current collector is stacked as the outermost layer of a multilayer.

The negative electrode active material layer includes the negative electrode active material as an essential material. The negative electrode active material is not particularly limited, and a known material which serves as a negative electrode active material for a non-aqueous secondary battery can be used. Examples of the negative electrode active material include: lithium transition metal oxides such as lithium titanate (Li₄Ti₅O₁₂); transition metal oxides such as TiO₂, Nb₂O₃ and WO3; a metal sulfide; a metal nitride; graphite; carbon materials such as soft carbon and hard carbon; silicon-based materials such as silicon alone, a silicon alloy and a silicon compound; lithium metal; a lithium alloy; indium metal; and the like.

The negative electrode active material layer may further include a solid electrolyte, a conductive aid, a binder and the like in addition to the negative electrode active material. The solid electrolyte, the conductive aid, the binder and the like are not particularly limited, and known materials which serve as electrode materials for a non-aqueous secondary battery can be applied.

The negative electrode current collector is not particularly limited, and a known material which serves as a negative electrode current collector for a non-aqueous secondary battery can be used. Examples of the negative electrode current collector include metal foils such as a copper (Cu) foil, a stainless steel (SUS) foil and an aluminum (Al) foil.

### (Electrolyte Layer)

The electrolyte layer includes a solid electrolyte as an essential material. The electrolyte layer may further include a binder and the like in addition to the solid electrolyte described above. In the present embodiment, the electrolyte layer is stacked between the positive electrode layer and the adhesive layer and the negative electrode layer.

Although the solid electrolyte is not particularly limited, examples thereof include a sulfide solid electrolyte, an oxide solid electrolyte, a nitride solid electrolyte, a halide solid electrolyte and the like.

### <Method for Manufacturing Non-Aqueous Secondary Battery Electrode>

A method for manufacturing a non-aqueous secondary battery electrode includes: preparing a positive electrode layer solution; forming a positive electrode layer; forming an electrolyte layer; preparing an adhesive layer solution; forming an adhesive layer; and stacking.

The order of these steps is not limited as long as the forming of each layer is performed after the preparing of the solution for the layer and the stacking is performed after the forming of the layers. For example, after the layers are formed independently, the stacking may be performed or after a certain layer is formed, another layer may be formed on the layer.

In the preparing of the positive electrode layer solution, the positive electrode layer solution in which components contained in the positive electrode active material layer are dissolved and/or dispersed in a first solvent is prepared. The first solvent has a lower solubility for the binder included in the positive electrode layer than a second solvent which will be described later.

In the preparing of the adhesive layer solution, the adhesive layer solution in which components contained in the adhesive layer are dissolved and/or dispersed in the second solvent is prepared. The second solvent has a higher solubility for the binder included in the positive electrode layer than the first solvent.

The first solvent and the second solvent are not particularly limited as long as a solvent which has affinity with materials included in the positive electrode layer solution and the adhesive layer solution is used, and examples thereof include aliphatic hydrocarbons, aromatic hydrocarbons, esters, ethers, ketones, nitriles and the like. According to the solubility for the previously selected binder, each of the first solvent and the second solvent can be selected.

The adhesive layer solution does not need to include a binder. In this way, the amount of binder in the positive electrode layer eluted in the adhesive layer solution is increased, and thus bondability between the positive electrode layer and the adhesive layer can be further enhanced. On the other hand, the adhesive layer solution may include the same type of binder as the binder included in the positive electrode layer solution. In this way, the compatibility between the binder included in the adhesive layer and the binder included in the positive electrode layer is enhanced, and thus the positive electrode layer and the adhesive layer can be bonded more continuously and strongly. The binder is included in the adhesive layer solution, and thus the applying property of the adhesive layer solution can be enhanced.

The second solvent has a higher solubility for the binder included in the positive electrode layer solution than the first solvent. In this way, the bonding between the positive electrode layer and the adhesive layer can be made more continuous or stronger. The effects described above will be described below with reference to drawings.

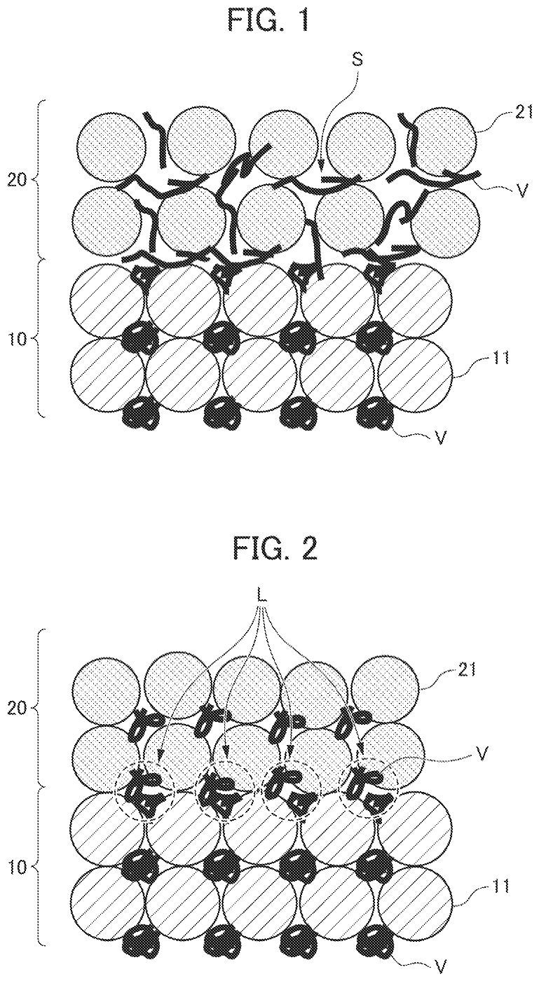

FIG. 1 is a cross-sectional diagram conceptually showing a state where the positive electrode layer and the adhesive layer in the present embodiment are stacked. Explanation of reference numerals shown in FIGS. 1 and 2 is as follows. 10: positive electrode layer (positive electrode layer solution), 11: positive electrode active material, 20: adhesive layer (adhesive layer solution), 21: solid electrolyte, V: binder, S: second solvent

In FIG. 1, in the adhesive layer 20, the second solvent S which has a higher solubility for the binder V than the first solvent is present. Hence, when the first solvent is present in the positive electrode layer 10, the binder V is compatible with the second solvent, and thus the movement of the binder V from the interior of the positive electrode layer 10 to the adhesive layer 20 is facilitated. Even when the first solvent is not present in the positive electrode layer 10, the binder V which is present in the positive electrode layer 10 is eluted by the second solvent to be moved to the adhesive layer 20.

FIG. 2 is a cross-sectional diagram conceptually showing a state where the positive electrode layer 10 and the adhesive layer 20 are bonded (stacked) through the state shown in FIG. 1. As shown in FIG. 2, in an interface L between the positive electrode layer 10 and the adhesive layer 20, the binder V moved from the positive electrode layer 10 to the adhesive layer 20 is present. The binder V here is drawn to the vicinity of the interface L by the second solvent, and is bonded and adhered to the solid electrolyte 21, the binder originally existing in the adhesive layer 20 and the like, with the result that the anchoring effect is achieved. In this way, voids at the interface L are filled, and thus the bonding between the positive electrode layer and the adhesive layer can be made more continuous or stronger.

The second solvent preferably has a lower boiling point than the first solvent. As described above, after the voids at the interface between the positive electrode layer and the adhesive layer are filled with the binder, the second solvent volatilizes smoothly, and thus the interface is easily filled with the binder and voids are unlikely to be generated at the interface. Hence, bondability between the positive electrode layer and the adhesive layer can be further enhanced.

The forming of the positive electrode layer is forming the positive electrode layer, and includes applying the positive electrode layer solution. A target to which the positive electrode layer solution is applied may be the adhesive layer. Alternatively, the forming of the positive electrode layer may be applying the positive electrode layer solution to an arbitrary target such as the positive electrode current collector and drying the positive electrode layer solution to independently form a sheet-shaped positive electrode layer. Examples of a method for applying the positive electrode layer solution include an application method using an applicator such as a doctor blade method, spray application, screen printing and the like.

The forming of the adhesive layer is forming the adhesive layer, and includes applying the adhesive layer solution. A target to which the adhesive layer solution is applied may be the positive electrode layer. Alternatively, the forming of the positive electrode layer may be applying the adhesive layer solution to an arbitrary target and drying the adhesive layer solution to independently form a sheet-shaped adhesive layer. However, the second solvent needs to be left in the adhesive layer which has been formed by the forming of the adhesive layer. As a method for applying the adhesive layer solution, the same method as the method for applying the positive electrode layer solution is mentioned.

The forming of the electrolyte layer is forming the electrolyte layer, and includes applying an electrolyte solution which includes components contained in the electrolyte layer. A target to which the electrolyte solution is applied may be the adhesive layer. Alternatively, the forming of the electrolyte layer may be applying the electrolyte solution to an arbitrary target and drying the electrolyte solution to independently form a sheet-shaped electrolyte layer. As a method for applying the electrolyte solution, the same method as the method for applying the positive electrode layer solution is mentioned.

The forming of each of the layers may include compressing the formed layer to increase its density. Although a compressing method in the compressing is not particularly limited, examples thereof include methods such as flat pressing, roll pressing and the like.

The stacking is stacking the positive electrode layer, the adhesive layer and the electrolyte layer formed by the forming of each of the layers in this order. The stacking may be stacking the layers each being formed independently. Alternatively, the stacking may be forming another layer on a certain layer formed independently. However, in such a case, the forming of each of the layers includes the stacking. The stacking may be combining stacking the layers each being formed independently and forming another layer on a certain layer formed independently.

In the stacking, when the positive electrode layer and the adhesive layer are stacked, the second solvent is preferably present at least in the adhesive layer. In this way, as described above, the binder present in the positive electrode layer is moved to the adhesive layer by the second solvent to make the bonding between the positive electrode layer and the adhesive layer more continuous or stronger. In addition, when the positive electrode layer and the adhesive layer are stacked, the first solvent is more preferably present at least in the positive electrode layer.

The forming of each of the layers or the stacking may include heating and compressing the layers and the multilayer of the layers. By the heating and compressing, the density of the layers can be increased, and the layers are brought into close contact and the binders are adhered to each other to enhance the bondability of the layers. However, as described above, when the positive electrode layer and the adhesive layer are stacked, the second solvent is preferably present at least in the adhesive layer. Hence, the heating and compressing is preferably performed on a multilayer after at least the positive electrode layer and the adhesive layer are stacked.

Although a heating and compressing method in the heating and compressing is not particularly limited, examples thereof include methods such as hot flat pressing, hot roll pressing and the like.

An example of the application of the method for manufacturing a non-aqueous secondary battery electrode will be described below. First, in the preparing of the positive electrode layer solution, a positive electrode layer solution which includes the positive electrode active material, SBR serving as the binder and butyl butyrate (boiling point of 165 degrees) serving as the first solvent is prepared. Then, in the forming of the positive electrode layer, a thin film is formed on an arbitrary target by the doctor blade method, the thin film is compressed with a roll press at a hertz surface pressure of 200 to 1,000 Mpa and thus its density is increased.

Then, in the forming of the electrolyte layer, an electrolyte solution which includes the solid electrolyte and the binder is used, a film is formed with an applicator, the film is compressed with a roll press at a hertz surface pressure of 200 to 1,000 Mpa and thus its density is increased.

Then, in the preparing of the adhesive layer solution, an adhesive layer solution which includes the solid electrolyte, toluene (boiling point of 110 degrees) serving as the second solvent, the solid electrolyte and the binder such as SBR as necessary is prepared. Then, in the forming of the adhesive layer including the stacking, the prepared adhesive layer solution is applied onto the formed positive electrode layer so as to have a thickness of 1 to 5 μm. Then, in the stacking, the electrolyte layer is transferred onto the formed adhesive layer, and rolling adhesion is performed with a roll press or the like.

Although in the example of the application described above, butyl butyrate is used as the first solvent, and toluene is used as the second solvent, for example, toluene can be used as the first solvent, and xylene can be used as the second solvent.

According to the method for manufacturing a non-aqueous secondary battery electrode in the present embodiment, the bonding between the positive electrode layer and the solid electrolyte layer can be made more continuous or stronger. Hence, the resistance of the interface between the positive electrode layer and the solid electrolyte layer is lowered, and this leads to an increase in battery capacity and the improvement of durability.

Although the preferred embodiment of the present invention has been described above, the present invention is not limited to the embodiment, and variations and modifications which can achieve the object of the present invention are included in the present invention.

### EXPLANATION OF REFERENCE NUMERALS

10 positive electrode layer
11 positive electrode active material
20 adhesive layer
21 solid electrolyte
V binder
S second solvent

What is claimed is:

1. A method for manufacturing a non-aqueous secondary battery electrode, the method comprising:
preparing a positive electrode layer solution that includes a positive electrode active material, a binder and a first solvent;
forming a positive electrode layer using the positive electrode layer solution;
forming an electrolyte layer that includes a solid electrolyte;
preparing an adhesive layer solution that includes a solid electrolyte and a second solvent;
forming an adhesive layer using the adhesive layer solution; and
stacking the positive electrode layer, the adhesive layer and the electrolyte layer in this order,
wherein the binder has a larger solubility in the second solvent than in the first solvent.

2. The method for manufacturing a non-aqueous secondary battery electrode according to claim 1, wherein the second solvent has a lower boiling point than the first solvent.

3. The method for manufacturing a non-aqueous secondary battery electrode according to claim 1, wherein in the stacking, when the positive electrode layer and the adhesive layer are stacked, the second solvent is present at least in the adhesive layer.

4. The method for manufacturing a non-aqueous secondary battery electrode according to claim 3, wherein the adhesive layer solution does not include a binder.

5. The method for manufacturing a non-aqueous secondary battery electrode according to claim 1, wherein the adhesive layer solution includes a same type of binder as the binder included in the positive electrode layer solution.
